(19) United States
(12) Patent Application Publication
(10) Pub. No.: US 2026/0156425 A1
(43) Pub. Date: Jun. 4, 2026

(54) ELECTRONIC DEVICE AND NON-TRANSITORY COMPUTER READABLE STORAGE MEDIUM PERFORMING VOLUME ADJUSTMENT FOR SPEAKER

(71) Applicant: SAMSUNG ELECTRONICS CO., LTD., Suwon-si (KR)

(72) Inventors: Hanki YOON, Suwon-si (KR); Min LEE, Suwon-si (KR); Soonkyu LEE, Suwon-si (KR)

(21) Appl. No.: 19/327,576

(22) Filed: Sep. 12, 2025

Related U.S. Application Data
(63) Continuation of application No. PCT/KR2025/012856, filed on Aug. 22, 2025.

(30) Foreign Application Priority Data
Dec. 2, 2024 (KR) 10-2024-0176752
Jan. 2, 2025 (KR) 10-2025-0000546

(51) Int. Cl. H04R 29/00; H04R 3/12

(52) U.S. Cl. CPC H04R 29/002; H04R 3/12; H04R 2430/01

(57) ABSTRACT

An electronic device includes a first speaker, a second speaker, at least one processor, and memory storing instructions. The instructions, when executed by the at least one processor individually or collectively, cause the electronic device to output audio data from the at least one processor to each of the first speaker and the second speaker, identify whether an output difference between a volume output from the first speaker and a volume output from the second speaker in a first frequency range and a second frequency range of the audio data is greater than a reference value, obtain a calibration value based on the output difference being greater than the reference value and adjust a volume of the first speaker or a volume of the second speaker by the calibration value.

### CROSS-REFERENCE TO RELATED APPLICATION(S)

This application is a continuation application, claiming priority under § 365(c), of an International application No. PCT/KR 2025/012856, filed on Aug. 22, 2025, which is based on and claims the benefit of a Korean patent application number 10-2025-0000546, filed on Jan. 2, 2025, in the Korean Intellectual Property Office, and of a Korean patent application number 10-2024-0176752, filed on Dec. 2, 2024, in the Korean Intellectual Property Office, the disclosure of each of which is incorporated by reference herein in its entirety.

### BACKGROUND

### 1. Field

The following descriptions relate to an electronic device and a non-transitory computer readable storage medium performing volume adjustment for a speaker.

### 2. Description of Related Art

An electronic device may provide spatial audio related to a location and a direction of a sound using speakers outputting the sound to different directions in the same frequency range. The electronic device may provide the spatial audio related to a depth and clarity of the sound using the speakers for providing the sound in different frequency ranges.

The above-described information may be provided as a related art for the purpose of helping understanding of the present disclosure. No argument or decision is made as to whether any of the above description may be applied as a prior art related to the present disclosure.

### SUMMARY

An electronic device is provided. The electronic device may comprise a first speaker, a second speaker, at least one processor comprising processing circuitry, and memory comprising one or more storage media storing instructions. The instructions, when executed by the at least one processor individually or collectively, may cause the electronic device to output audio data from the at least one processor to each of the first speaker and the second speaker. The instructions, when executed by the at least one processor individually or collectively, may cause the electronic device to identify whether an output difference between a volume output from the first speaker and a volume output from the second speaker in a first frequency range and a second frequency range of the audio data is greater than a reference value. The instructions, when executed by the at least one processor individually or collectively, may cause the electronic device to, based on the output difference greater than the reference value being identified, obtain a calibration value. The instructions, when executed by the at least one processor individually or collectively, may cause the electronic device to, based on obtaining the calibration value, adjust a volume of the first speaker or a volume of the second speaker by the calibration value.

A non-transitory computer readable storage medium is provided. The non-transitory computer readable storage medium may store one or more programs. The one or more programs may comprise instructions to, when executed by an electronic device with a first speaker and a second speaker, cause the electronic device to output audio data to each of the first speaker and the second speaker. The one or more programs may comprise instructions to, when executed by the electronic device, cause the electronic device to identify whether an output difference between a volume output from the first speaker and a volume output from the second speaker in a first frequency range and a second frequency range of the audio data is greater than a reference value. The one or more programs may comprise instructions to, when executed by the electronic device to, based on the output difference greater than the reference value being identified, obtain a calibration value. The one or more programs may comprise instructions to, when executed by the electronic device to, based on obtaining the calibration value, adjust a volume of the first speaker or a volume of the second speaker by the calibration value.

An electronic device is provided. The electronic device may comprise a first speaker, a second speaker, at least one processor comprising processing circuitry, and memory comprising one or more storage media storing instructions. The at least one processor may include a digital signal processor comprising the processing circuitry for processing audio data. The instructions, when executed by the at least one processor individually or collectively, may cause the electronic device to identify a stream type of the audio data to be output from the at least one processor to each of the first speaker and the second speaker. The instructions, when executed by the at least one processor individually or collectively, may cause the electronic device to, based on the stream type of the audio data being identified as a defined stream type, perform, via the digital signal processor, a volume adjustment between the first speaker and the second speaker. The instructions, when executed by the at least one processor individually or collectively, may cause the electronic device to, based on the stream type of the audio data not being identified as the defined stream type, refrain from the volume adjustment.

A non-transitory computer readable storage medium is provided. The non-transitory computer readable storage medium may store one or more programs. The one or more programs may comprise instructions to, when executed by an electronic device with a first speaker, a second speaker, and a digital signal processor comprising processing circuitry for processing audio data, cause the electronic device to identify a stream type of the audio data to be output to each of the first speaker and the second speaker. The one or more programs may comprise instructions to, when executed by the electronic device, cause the electronic device to, based on the stream type of the audio data being identified as a defined stream type, perform, via the digital signal processor, a volume adjustment between the first speaker and the second speaker. The one or more programs may comprise instructions to, when executed by the electronic device, cause the electronic device to, based on the stream type of the audio data not being identified as the defined stream type, refrain from the volume adjustment.

### BRIEF DESCRIPTION OF THE DRAWINGS

FIG. 1 is a schematic view of an exemplary electronic device.

FIG. 2 illustrates an example of a calibration environment for volume adjustment of a speaker of an electronic device.

FIG. 3 is a flowchart illustrating a method of performing volume adjustment of a speaker of an electronic device.

FIG. 4 illustrates another example of a calibration environment for volume adjustment of a speaker of an electronic device.

FIG. 5 is a flowchart illustrating a method of setting a volume of each of speakers of an electronic device using a calibration value.

FIG. 6 illustrates another example of a calibration environment for volume adjustment of a speaker of an electronic device.

FIG. 7 is a flowchart illustrating a method of performing volume adjustment between speakers according to a stream type of audio data.

FIG. 8 is a block diagram of an electronic device in a network environment according to various embodiments.

### DETAILED DESCRIPTION

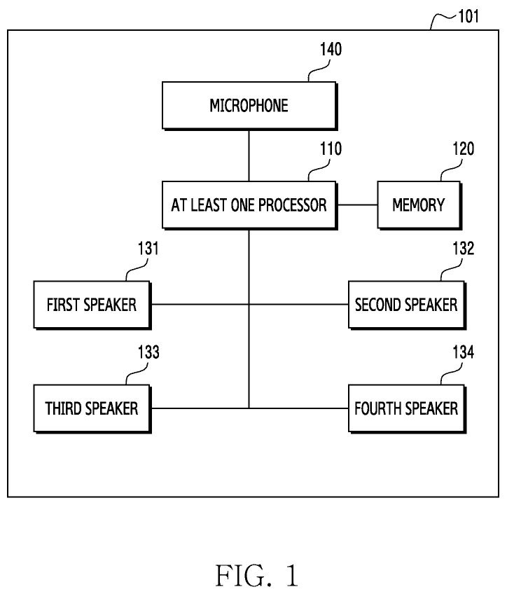

FIG. 1 is a schematic view of an exemplary electronic device.

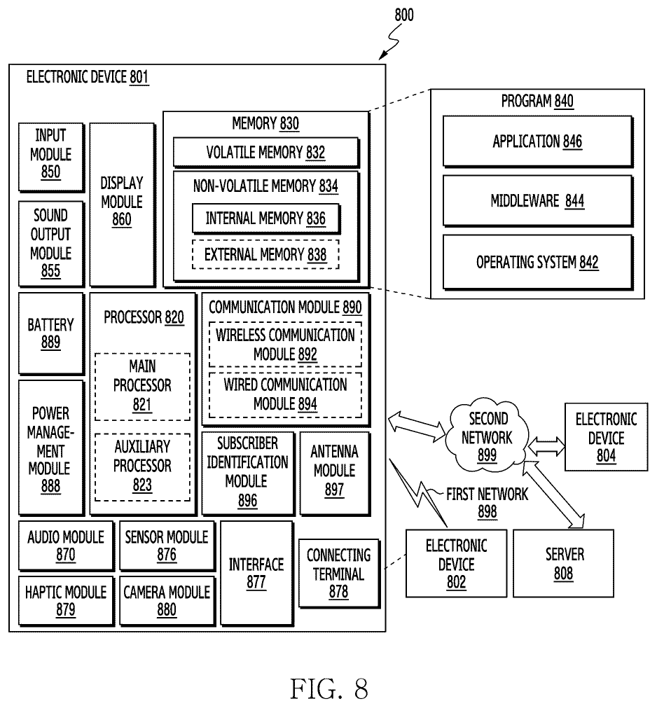

Referring to FIG. 1, an electronic device 101 may include at least one processor 110, memory 120, a first speaker 131, a second speaker 132, a third speaker 133, a fourth speaker 134, and a microphone 140. The electronic device 101 may include at least a portion of an electronic device 801 of FIG. 8, or may correspond to at least a portion of the electronic device 801 of FIG. 8.

The at least one processor 110 may include processing circuitry. The at least one processor 110 may include a single processor or multiple processors. The at least one processor 110 may control the memory 120 and/or one or more components (e.g., the first speaker 131, the second speaker 132, the third speaker 133, the fourth speaker 134, and the microphone 140) of the electronic device 101. For example, the at least one processor 110 may identify audio data to be output to each of the first speaker 131, the second speaker 132, the third speaker 133, and the fourth speaker 134. For example, the audio data may be described as data related to audio (e.g., music, a voice, and a media sound) to be played in the electronic device 101. For example, the at least one processor 110 may receive a signal about a sound detected (or identified) by the microphone 140 from the microphone 140. For example, the at least one processor 110 may include at least a portion of a processor 820 of FIG. 8, or may correspond to at least a portion of the processor 820 of FIG. 8.

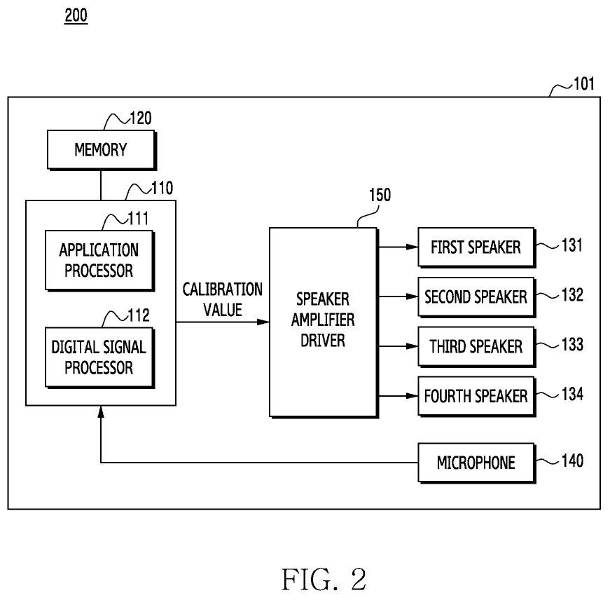

The memory 120 may store one or more programs configured to be individually and/or collectively executed by the at least one processor 110. The one or more programs may include instructions. The instructions may cause the electronic device 101 to perform operations described with reference to FIGS. 2 to 7. The memory 120 may include one or more storage media. At least a portion of the one or more programs may be available to manage, control, and/or execute a program related to a speaker amplifier driver, which will be described below. For example, the memory 120 may include at least a portion of memory 830 of FIG. 8, or may correspond to at least a portion of the memory 830 of FIG. 8.

The first speaker 131, the second speaker 132, the third speaker 133, and the fourth speaker 134 may output the audio data identified by the at least one processor 110 to an outside of the electronic device 101. For example, the first speaker 131, the second speaker 132, the third speaker 133, and the fourth speaker 134 may include at least a portion of a sound output module 855 of FIG. 8, or may correspond to at least a portion of the sound output module 855 of FIG. 8. As an example without limitation, the first speaker 131, the second speaker 132, the third speaker 133, and the fourth speaker 134 may be configured as external speakers located outside the electronic device 101. As an example without limitation, the first speaker 131 and the second speaker 132 may be described as a woofer outputting a sound related to audio data on a low frequency range. As an example without limitation, the third speaker 133 and the fourth speaker 134 may be described as a tweeter outputting a sound related to audio data on a high frequency range. For example, the woofer and the tweeter may provide spatial audio related to a depth and clarity of the sound by outputting the sound in different frequency ranges.

For example, the first speaker 131 and the second speaker 132 may output audio data on a frequency range (e.g., the low frequency range) to the outside of the electronic device 101. For example, the first speaker 131 and the second speaker 132 may output a sound related to the audio data on the frequency range (e.g., the low frequency range) provided by the at least one processor 110 to different directions. For example, the first speaker 131 may be disposed on a side (e.g., left side) of the electronic device 101. For example, the second speaker 132 may be disposed on another side (e.g., right side) facing the side of the electronic device 101. For example, the first speaker 131 and the second speaker 132 may provide spatial audio related to a location and a direction of the sound by outputting the sound to the different directions in the same frequency range.

For example, the third speaker 133 and the fourth speaker 134 may output audio data on a frequency range (e.g., the high frequency range) to the outside of the electronic device 101. For example, the third speaker 133 and the fourth speaker 134 may output a sound related to the audio data on the frequency range (e.g., the high frequency range) provided by the at least one processor 110 to different directions. For example, the third speaker 133 may be disposed on a side (e.g., left side) of the electronic device 101. For example, the fourth speaker 134 may be disposed on another side (e.g., right side) facing the side of the electronic device 101. For example, the third speaker 133 and the fourth speaker 134 may provide spatial audio related to a location and a direction of the sound by outputting sound to the different directions in the same frequency range.

The microphone 140 may detect (or identify) a sound of the surrounding environment of the electronic device 101. For example, the microphone 140 may detect (or identify) a sound output from each of the first speaker 131, the second speaker 132, the third speaker 133, and the fourth speaker 134. By converting the detected sound into a signal, the microphone 140 may transmit the converted signal to the at least one processor 110. For example, the microphone 140 may include at least a portion of an input module 850 of FIG. 8, or may correspond to at least a portion of the input module 850 of FIG. 8.

FIG. 2 illustrates an example of a calibration environment for volume adjustment of a speaker of an electronic device.

Referring to FIG. 2, a calibration environment 200 related to an electronic device 101 is illustrated.

The electronic device 101 may include at least one processor 110, memory 120, a first speaker 131, a second speaker 132, a third speaker 133, and a fourth speaker 134. The electronic device 101 may further include a microphone 140 and a speaker amplifier driver 150.

For example, the electronic device 101 may increase precision of spatial audio output from speakers by performing volume adjustment between the first speaker 131 and the second speaker 132 and volume adjustment between the third speaker 133 and the fourth speaker 134. However, the description is not limited thereto. For example, the electronic device 101 may perform only volume adjustment between the first speaker 131 and the second speaker 132, or may perform only volume adjustment between the third speaker 133 and the fourth speaker 134. For another example, the electronic device 101 may perform volume adjustment between three or more speakers.

The at least one processor 110 may include an application processor (AP) 111 and a digital signal processor (DSP) 112. For example, the application processor 111 and the digital signal processor 112 may be integrated into a component (e.g., a single chip), or may be implemented as a plurality of separate components (e.g., a plurality of chips).

The application processor 111 may identify audio data to be provided to each of the first speaker 131, the second speaker 132, the third speaker 133, and the fourth speaker 134. For example, the audio data may be described as data related to audio (e.g., music, a voice, and a media sound) to be played in the electronic device 101. For example, the application processor 111 may adjust a size (e.g., gain) of a signal related to the audio data, or filter a frequency of the signal, and/or determine bit depth of the audio data. For example, the application processor 111 may identify audio data components by analyzing (or identifying) the audio data for each frequency range. For example, the application processor 111 may identify, from the audio data, a first audio data component on a first frequency range, a second audio data component on a second frequency range higher than the first frequency range, a third audio data component on a third frequency range higher than the second frequency range, and a fourth audio data component on a fourth frequency range higher than the third frequency range. For example, the first audio data component, the second audio data component, the third audio data component, and the fourth audio data component may be included in the audio data. As an example without limitation, the first frequency range and the second frequency range may be described as a low frequency range. As an example without limitation, the third frequency range and the fourth frequency range may be described as a high frequency range.

For example, a software layer of the application processor 111 may be described as including an application layer and a framework layer. For example, the application processor 111 may identify audio data to be played in the electronic device 101 via the application layer. For example, the application processor 111 may set a playback environment (e.g., stereo or mono) related to the audio data to be played in the electronic device 101 via the framework layer, and/or set a playback priority for the audio data to be played in the electronic device 101.

For example, the application processor 111 may calculate (or identify) a calibration value for the volume adjustment between the first speaker 131 and the second speaker 132 and the volume adjustment between the third speaker 133 and the fourth speaker 134 via the application layer. For example, the application processor 111 may store the calibration value calculated (or identified) via the framework layer in the memory 120. For example, the calibration value may include a first calibration value for the volume adjustment between the first speaker 131 and the second speaker 132 and a second calibration value for the volume adjustment between the third speaker 133 and the fourth speaker 134. For example, when the electronic device 101 is booted, the application processor 111 may read the first calibration value and the second calibration value stored in the memory 120 via the framework layer. The application processor 111 may store the read first calibration value and the read second calibration value in a register of the speaker amplifier driver 150 via the framework layer.

The digital signal processor 112 may include processing circuitry for processing the audio data identified by the application processor 111. For example, the digital signal processor 112 may output the audio data to be output to an outside of the electronic device 101 to the first speaker 131, the second speaker 132, the third speaker 133, and the fourth speaker 134, via the speaker amplifier driver 150. For example, the digital signal processor 112 may output the first audio data component on the first frequency range and the second audio data component on the second frequency range to each of the first speaker 131 and the second speaker 132 via the speaker amplifier driver 150. For example, the digital signal processor 112 may output the third audio data component on the third frequency range and the fourth audio data component on the fourth frequency range to each of the third speaker 133 and the fourth speaker 134 via the speaker amplifier driver 150. For example, the digital signal processor 112 may adjust a size (e.g., gain) of a signal related to the audio data and/or filter a frequency of the audio data.

The speaker amplifier driver 150 may be electrically connected to the first speaker 131, the second speaker 132, the third speaker 133, and the fourth speaker 134. For example, by processing the audio data output from the digital signal processor 112, the speaker amplifier driver 150 may output the processed audio data to the outside of the electronic device 101 via each of the first speaker 131, the second speaker 132, the third speaker 133, and the fourth speaker 134.

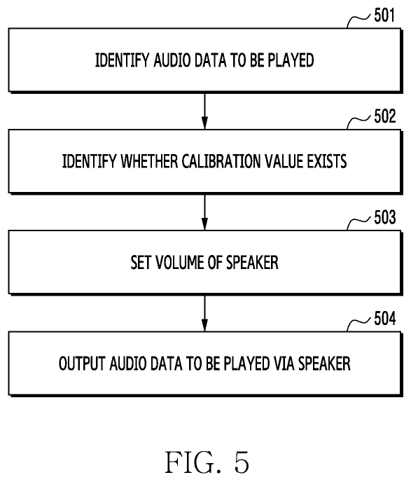

For example, the speaker amplifier driver 150 may set a volume of each of the first speaker 131, the second speaker 132, the third speaker 133, and the fourth speaker 134 based on a program executed by the at least one processor 110. For example, the program may be stored in the memory 120 in relation to the speaker amplifier driver 150. For example, the speaker amplifier driver 150 may perform the volume adjustment between the first speaker 131 and the second speaker 132, using the first calibration value based on the program. For example, the first calibration value may be stored in the register of the speaker amplifier driver 150. For example, the speaker amplifier driver 150 may adjust a volume of the first speaker 131 or a volume of the second speaker 132 by the first calibration value. For example, the speaker amplifier driver 150 may perform the volume adjustment between the third speaker 133 and the fourth speaker 134, using the second calibration value based on the program. For example, the second calibration value may be stored in the register of the speaker amplifier driver 150. For example, the speaker amplifier driver 150 may adjust a volume of the third speaker 133 or a volume of the fourth speaker 134 by the second calibration value. An operation method of setting the volume of each of the speakers using the calibration value will be described later with reference to FIG. 5.

The electronic device 101 may, using the microphone 140, increase the precision of the spatial audio output from the speakers by performing the volume adjustment between the first speaker 131 and the second speaker 132 and the volume adjustment between the third speaker 133 and the fourth speaker 134.

For example, even if the volume of the first speaker 131 and the volume of the second speaker 132 are set to be equal, the volume output from the first speaker 131 and the volume output from the second speaker 132 can become different due to a difference in a hardware structure between the first speaker 131 and the second speaker 132 or other factors impacting volume output, so the electronic device 101 may increase the precision of the spatial audio by performing the volume adjustment. For example, since the difference in an output volume between the first speaker 131 and the second speaker 132 that occurs according to the difference in the hardware structure becomes different for each frequency range, the electronic device 101 may obtain the first calibration value for the volume adjustment by identifying the difference in the output volume in two different frequency ranges (e.g., the first frequency range and the second frequency range).

For example, even if the volume of the third speaker 133 and the volume of the fourth speaker 134 are set equal, the volume output from the third speaker 133 and the volume output from the fourth speaker 134 become different due to a difference in a hardware structure between the third speaker 133 and the fourth speaker 134, so the electronic device 101 may increase the precision of the spatial audio by performing the volume adjustment. For example, the difference in the volume output from the third speaker 133 and the fourth speaker 134 that occurs according to the difference in the hardware structure becomes different for each frequency range. For example, since the difference in an output volume between the third speaker 133 and the fourth speaker 134 that occurs according to the difference in the hardware structure becomes different for each frequency range, the electronic device 101 may obtain the second calibration value for the volume adjustment by identifying the difference in the output volume in two different frequency ranges (e.g., the third frequency range and the fourth frequency range).

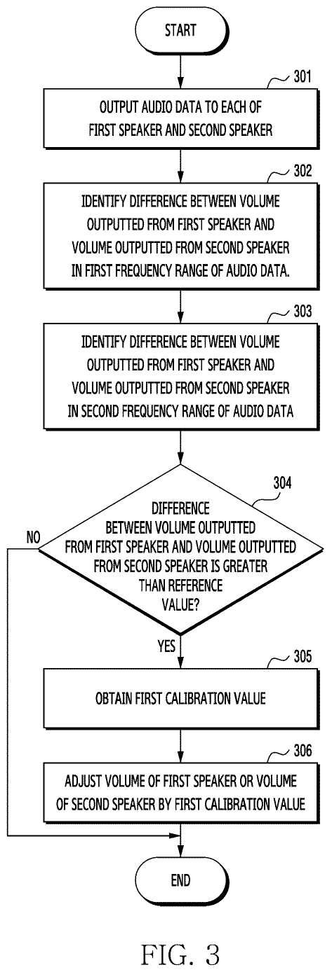

A method of an operation of the electronic device 101 performing the volume adjustment will be described with reference to FIG. 3.

FIG. 3 is a flowchart illustrating a method of performing volume adjustment of a speaker of an electronic device.

Referring to FIG. 3, a method of an operation of the electronic device 101 performing volume adjustment between a first speaker 131 and a second speaker 132 is illustrated. As an example without limitation, the first speaker 131 and the second speaker 132 may be described as a woofer outputting a sound related to audio data on a low frequency range.

In an operation 301, at least one processor 110 may output audio data to each of the first speaker 131 and the second speaker 132. For example, the at least one processor 110 may identify, from the audio data, a first audio data component on a first frequency range and a second audio data component on a second frequency range. For example, the audio data may be described as data related to audio (e.g., music, a voice, and a media sound) to be played in the electronic device 101. As an example without limitation, the first frequency range and the second frequency range may be described as a low frequency range. For example, the first frequency range may include 200 Hz. For example, the second frequency range may include 1 kHz.

In an operation 302, the at least one processor 110 may identify an output difference between a volume output from the first speaker 131 and a volume outputted from the second speaker 132 in the first frequency range of the audio data. For example, by outputting the first audio data component on the first frequency range to each of the first speaker 131 and the second speaker 132, the at least one processor 110 may identify the volume output from the first speaker 131 and the volume output from the second speaker 132, using a microphone 140. For example, the at least one processor 110 may identify a value corresponding to the difference between the volume output from the first speaker 131 in the first frequency range and the volume output from the second speaker 132 in the first frequency range as the first value. For example, the first value may correspond to a value obtained by subtracting the volume output from the second speaker 132 in the first frequency range from the volume output from the first speaker 131 in the first frequency range. For example, in a case that a volume output from the first speaker 131 in the first frequency range is 87 dB and a volume output from the second speaker 132 in the first frequency range is 85 dB, the at least one processor 110 may identify 2 dB as the first value. For example, the first value identified as a positive number may indicate that the volume output from the first speaker 131 in the first frequency range is greater than the volume output from the second speaker 132. For another example, in a case in which the volume output from the first speaker 131 in the first frequency range is 87 dB and a volume output from the second speaker 132 in the first frequency range is 89 dB, the at least one processor 110 may identify −2 dB as the first value. For example, the first value identified as a negative number may indicate that the volume output from the second speaker 132 in the first frequency range and is greater than the volume output from the first speaker 131.

In an operation 303, the at least one processor 110 may identify an output difference between the volume output from the first speaker 131 and the volume output from the second speaker 132 in the second frequency range of the audio data. For example, by outputting the second audio data component on the second frequency range to each of the first speaker 131 and the second speaker 132, the at least one processor 110 may identify the volume output from the first speaker 131 in the second frequency range and the volume output from the second speaker 132 in the second frequency range, using the microphone 140. For example, the at least one processor 110 may identify a value corresponding to a difference between the volume output from the first speaker 131 in the second frequency range and the volume output from the second speaker 132 in the second frequency range as a second value. For example, the second value may correspond to a value obtained by subtracting the volume output from the second speaker 132 in the second frequency range from the volume output from the first speaker 131 in the second frequency range. For example, in a case that a volume output from the first speaker 131 in the second frequency range is 91 dB and a volume output from the second speaker 132 in the second frequency range is 87 dB, the at least one processor 110 may identify 4 dB as the second value. For example, the second value identified as the positive number may indicate that the volume output from the first speaker 131 in the second frequency range is greater than the volume output from the second speaker 132. For another example, in a case that a volume output from the first speaker 131 in the second frequency range is 91 dB and a volume output from the second speaker 132 in the second frequency range is 92 dB, the at least one processor 110 may identify −1 dB as the second value. For example, the second value identified as the negative number may indicate that the volume output from the second speaker 132 in the second frequency range and is greater than the volume output from the first speaker 131.

In an operation 304, the at least one processor 110 may identify whether the output difference between the volume output from the first speaker 131 and the volume output from the second speaker 132 in the first frequency range and the second frequency range of the audio data is greater than a reference value. As an example without limitation, the reference value may be described as a value related to a specification for ensuring precision of spatial audio. The reference value may be variously set according to an embodiment. For example, the reference value may be set to 3 dB. For example, the at least one processor 110 may identify that the output difference between the volume output from the first speaker 131 and the volume output from the second speaker 132 is greater than the reference value, based on an absolute value of the first value greater than the reference value or an absolute value of the second value greater than the reference value being identified.

In an operation 305, the at least one processor 110 may obtain a first calibration value, based on the output difference greater than the reference value being identified. For example, in a case in which the absolute value of the first value is 2 dB and the absolute value of the second value is 4 dB, since the absolute value of the second value is greater than 3 dB which is the reference value, the at least one processor 110 may obtain the first calibration value. For another example, in a case in which the absolute value of the first value is 2 dB and the absolute value of the second value is 1 dB, since both the absolute value of the first value and the absolute value of the second value are less than 3 dB which is the reference value, the at least one processor 110 may refrain from obtaining the first calibration value.

For example, the first calibration value may be for adjusting the output difference between the volume output from the first speaker 131 and the volume output from the second speaker 132 to be less than or equal the reference value. For example, the first calibration value may be between the first value and the second value. For example, the first calibration value may correspond to an average value of the first value and the second value. For example, in a case in which the first value is 2 dB and the second value is 4 dB, the at least one processor 110 may identify 3 dB as the first calibration value. For another example, in a case in which the first value is 2 dB and the second value is −4 dB, the at least one processor 110 may identify −1 dB as the first calibration value. For example, in a case in which the average value is greater than the reference value (e.g., 3 dB), the at least one processor 110 may set the reference value as the first calibration value. For example, based on the average value less than another reference value (e.g., −3 dB) being identified, the at least one processor 110 may identify the another reference value as the first calibration value. For example, the another reference value may be less than the reference value. For example, the reference value and the another reference value may have different signs and the same absolute value. As an example without limitation, the another reference value may be described as a value related to the specification for ensuring the precision of the spatial audio. For example, based on obtaining the first calibration value, the at least one processor 110 may store the obtained first calibration value in the memory 120.

For example, in a case in which the reference value and the another reference value are set to 3 dB and −3 dB, respectively, the precision of the spatial audio may be ensured when a value (e.g., the first value and the second value) obtained by subtracting the volume output from the second speaker 132 from the volume output from the first speaker 131 is in a range between 3 dB and −3 dB. For example, in a case in which the volume output from the first speaker 131 is greater than the volume output from the second speaker 132 by more than 3 dB, since the subtracted value is greater than the reference value, the volume of the first speaker 131 or the volume of the second speaker 132 may be adjusted according to an operation 306 described below, using the first calibration value. For example, in a case in which the volume output from the first speaker 131 is lower than the volume output from the second speaker 132 by more than 3 dB, since the subtracted value is less than the another reference value, the volume of the first speaker 131 or the volume of the second speaker 132 may be adjusted according to the operation 306 described below, using the first calibration value.

For example, in a case in which the value (e.g., the first value and the second value) obtained by subtracting the volume output from the second speaker 132 from the volume output from the first speaker 131 is greater than a threshold value (e.g., 6 dB), the at least one processor 110 may refrain from obtaining the first calibration value and identify a state of the first speaker 131 and/or the second speaker 132 as a defective (or failure) state. For example, the threshold value may be described as a value for determining defect in the first speaker 131 and the second speaker 132 in relation to the precision of the spatial audio. For example, in a case in which the reference value and the another reference value are set to 3 dB and −3 dB, respectively, the precision of the spatial audio may be ensured when the value (e.g., the first value and the second value) obtained by subtracting the volume output from the second speaker 132 from the volume output from the first speaker 131 is in the range between 3 dB and −3 dB. For example, in a case in which the subtracted value is greater than 6 dB which is the threshold value, the state of the first speaker 131 and/or the second speaker 132 may be identified as a defective (or failure) state in relation to the spatial audio, since the first calibration value for adjusting the subtracted value in the range is greater than 3 dB.

In an operation 306, the at least one processor 110 may adjust the volume of the first speaker 131 or the volume of the second speaker 132 by the first calibration value, based on obtaining the first calibration value. For example, the at least one processor 110 may, when the electronic device 101 is booted, read the first calibration value stored in the memory 120. For example, the at least one processor 110 may store the read first calibration value in a register of a speaker amplifier driver 150. For example, the at least one processor 110 may control the speaker amplifier driver 150 to adjust the volume of the first speaker 131 or the volume of the second speaker 132, using the first calibration value stored in the register. For example, the volume adjustment may be for adjusting the output difference to be less than or equal to the reference value, using the first calibration value. For example, in a case in which the first calibration value is identified as 3 dB as the first value is identified as 2 dB and the second value is identified as 4 dB, the at least one processor 110 may reduce the volume of the first speaker 131 by 3 dB or increase the volume of the second speaker 132 by 3 dB. For example, each of the first value and the second value may be identified as −1 dB and 1 dB. For another example, in a case in which the first calibration value is identified as −1 dB as the first value is identified as 2 dB and the second value is identified as −4 dB, the at least one processor 110 may increase the volume of the first speaker 131 by 1 dB or reduce the volume of the second speaker 132 by 1 dB. For example, each of the first value and the second value may be identified as 3 dB and −3 dB.

As an example without limitation, the calibration value may also be set differently according to a frequency range. For example, by identifying the volume output from the speakers in an entire frequency range, the electronic device 101 may obtain a frequency response indicating an output volume of the speaker in the entire frequency range. For example, the electronic device 101 may identify calibration values for adjusting the obtained frequency response to a reference frequency response. For example, the electronic device 101 may also calibrate the volume of the speakers for each frequency range, using the identified calibration values.

For example, the method of the operation of performing the volume adjustment between the first speaker 131 and the second speaker 132 in FIG. 3 may be the same as the method of the operation of performing the volume adjustment between the third speaker 133 and the fourth speaker 134. As an example without limitation, the third speaker 133 and the fourth speaker 134 may be described as a tweeter outputting a sound related to audio data on a high frequency range.

In an operation corresponding to the operation 301, the at least one processor 110 may output the audio data to each of the third speaker 133 and the fourth speaker 134. For example, the at least one processor 110 may, from the audio data, identify a third audio data component on a third frequency range and a fourth audio data component on a fourth frequency range. For example, the audio data may be described as data related to audio (e.g., music, a voice, and a media sound) to be played in the electronic device 101. As an example without limitation, the third frequency range and the fourth frequency range may be described as the high frequency range. For example, the third frequency range may include 3 kHz. For example, the fourth frequency range may include 5 kHz. For example, each of the third frequency range and the fourth frequency range may be higher than the first frequency range and the second frequency range.

In an operation corresponding to the operation 302, the at least one processor 110 may identify an output difference between the volume output from the third speaker 133 and the volume output from the fourth speaker 134 in the third frequency range of the audio data. For example, by outputting the third audio data component on the third frequency range to each of the third speaker 133 and the fourth speaker 134, the at least one processor 110 may identify the volume output from the third speaker 133 and the volume output from the fourth speaker 134, using the microphone 140. For example, the at least one processor 110 may identify a value corresponding to a difference between the volume output from the third speaker 133 in the third frequency range and the volume output from the fourth speaker 134 in the third frequency range as a third value. For example, the third value may correspond to a value obtained by subtracting the volume output from the fourth speaker 134 in the third frequency range from the volume output from the third speaker 133 in the third frequency range. For example, in a case that a volume output from the third speaker 133 in the third frequency range is 92 dB and a volume output from the fourth speaker 134 in the third frequency range is 90 dB, the at least one processor 110 may identify 2 dB as the third value. For example, the third value identified as the positive number may indicate that the volume output from the third speaker 133 in the third frequency range is greater than the volume output from the fourth speaker 134. For another example, in a case that a volume output from the third speaker 133 in the third frequency range is 92 dB and a volume output from the fourth speaker 134 in the third frequency range is 94 dB, the at least one processor 110 may identify −2 dB as the third value. For example, the third value identified as the negative number may indicate that the volume output from the fourth speaker 134 in the third frequency range is greater than the volume output from the third speaker 133.

In an operation corresponding to the operation 303, the at least one processor 110 may identify an output difference between the volume output from the third speaker 133 and the volume output from the fourth speaker 134 in the fourth frequency range of the audio data. For example, by outputting the fourth audio data component on the fourth frequency range to each of the third speaker 133 and the fourth speaker 134, the at least one processor 110 may identify the volume output from the third speaker 133 in the fourth frequency range and the volume output from the fourth speaker 134 in the fourth frequency range, using the microphone 140. For example, the at least one processor 110 may identify a value corresponding to a difference between the volume output from the third speaker 133 in the fourth frequency range and the volume output from the fourth speaker 134 in the fourth frequency range as a fourth value. For example, the fourth value may correspond to a value obtained by subtracting the volume output from the fourth speaker 134 in the fourth frequency range from the volume output from the third speaker 133 in the fourth frequency range. For example, in a case that a volume output from the third speaker 133 in the fourth frequency range is 96 dB and a volume output from the fourth speaker 134 in the fourth frequency range is 92 dB, the at least one processor 110 may identify 4 dB as the fourth value. For example, the fourth value identified as the positive number may indicate that the volume output from the third speaker 133 in the fourth frequency range is greater than the volume output from the fourth speaker 134. For another example, in a case that a volume output from the third speaker 133 in the fourth frequency range is 96 dB and a volume output from the fourth speaker 134 in the fourth frequency range is 97 dB, the at least one processor 110 may identify −1 dB as the fourth value. For example, the fourth value identified as the negative number may indicate that the volume output from the fourth speaker 134 in the fourth frequency range is greater than the volume output from the third speaker 133.

In an operation corresponding to the operation 304, the at least one processor 110 may identify whether the output difference between the volume output from the third speaker 133 and the volume output from the fourth speaker 134 in the third frequency range and the fourth frequency range of the audio data is greater than a reference value. As an example without limitation, the reference value may be described as a value related to the specification for ensuring the precision of the spatial audio. The reference value may be variously set according to an embodiment. For example, the reference value may be set to 3 dB. For example, the at least one processor 110 may identify that the output difference between the volume output from the third speaker 133 and the volume output from the fourth speaker 134 is greater than the reference value, based on an absolute value of the third value greater than the reference value or an absolute value of the fourth value greater than the reference value being identified.

In an operation corresponding to the operation 305, the at least one processor 110 may obtain a second calibration value, based on the output difference greater than the reference value being identified. For example, in a case in which the absolute value of the third value is 2 dB and the absolute value of the fourth value is 4 dB, since the absolute value of the fourth value is greater than 3 dB which is the reference value, the at least one processor 110 may obtain the second calibration value. For another example, in a case in which the absolute value of the third value is 2 dB and the absolute value of the fourth value is 1 dB, since both the absolute value of the third value and the absolute value of the fourth value are less than 3 dB which is the reference value, the at least one processor 110 may refrain from obtaining the second calibration value.

For example, the second calibration value may be for adjusting the output difference between the volume output from the third speaker 133 and the volume output from the fourth speaker 134 to be less than or equal the reference value. For example, the second calibration value may be between the third value and the fourth value. For example, the second calibration value may correspond to an average value of the third value and the fourth value. For example, in a case in which the third value is 2 dB and the fourth value is 4 dB, the at least one processor 110 may identify 3 dB as the second calibration value. For another example, in a case in which the third value is 2 dB and the fourth value is −4 dB, the at least one processor 110 may identify −1 dB as the second calibration value. For example, in a case in which the average value is greater than the reference value (e.g., 3 dB), the at least one processor 110 may set the reference value as the second calibration value. For example, based on the average value less than another reference value (e.g., −3 dB) being identified, the at least one processor 110 may identify the another reference value as the second calibration value. For example, the another reference value may be less than the reference value. For example, the reference value and the another reference value may have different signs and the same absolute value. As an example without limitation, the another reference value may be described as a value related to the specification for ensuring the precision of the spatial audio. For example, based on obtaining the second calibration value, the at least one processor 110 may store the second calibration value in the memory 120.

For example, in a case in which the reference value and the another reference value are set to 3 dB and −3 dB, respectively, the precision of the spatial audio may be ensured when a value (e.g., the third value and the fourth value) obtained by subtracting the volume output from the fourth speaker 134 from the volume output from the third speaker 133 is in the range between 3 dB and −3 dB. For example, in a case in which the volume outputted from the third speaker 133 is greater than the volume outputted from the fourth speaker 134 by more than 3 dB, since the subtracted value is greater than the reference value, the volume of the third speaker 133 or the volume of the fourth speaker 134 may be adjusted according to the operation 306 described below, using the second calibration value. For example, in a case in which the volume output from the third speaker 133 is lower than the volume output from the fourth speaker 134 by more than 3 dB, since the subtracted value is less than the another reference value, the volume of the third speaker 133 or the volume of the fourth speaker 134 may be adjusted according to the operation 306 described below, using the second calibration value.

For example, in a case in which the value (e.g., the third value and the fourth value) obtained by subtracting the volume output from the fourth speaker 134 from the volume output from the third speaker 133 is greater than a threshold value (e.g., 6 dB), the at least one processor 110 may refrain from obtaining the second calibration value and identify a state of the third speaker 133 and/or the fourth speaker 134 as a defective (or failure) state. For example, the threshold value may be described as a value for determining defect in the third speaker 133 and the fourth speaker 134 in relation to the precision of the spatial audio. For example, in a case in which the reference value and the another reference value are set to 3 dB and −3 dB, respectively, the precision of the spatial audio may be ensured when the value (e.g., the third value and the fourth value) obtained by subtracting the volume output from the fourth speaker 134 from the volume output from the third speaker 133 is in the range between 3 dB and −3 dB. For example, in a case in which the subtracted value is greater than 6 dB which is the threshold value, the state of the third speaker 133 and/or the fourth speaker 134 may be identified as a defective (or failure) state in relation to the spatial audio, since the second calibration value for adjusting the subtracted value in the range is greater than 3 dB.

In an operation corresponding to the operation 306, the at least one processor 110 may adjust the volume of the third speaker 133 or the volume of the fourth speaker 134 by the second calibration value, based on obtaining the second calibration value. For example, the at least one processor 110 may, when the electronic device 101 is booted, read the second calibration value stored in the memory 120. For example, the at least one processor 110 may store the read second calibration value in a register of the speaker amplifier driver 150. For example, the at least one processor 110 may control the speaker amplifier driver 150 to adjust the volume of the third speaker 133 or the volume of the fourth speaker 134, using the second calibration value stored in the register. For example, the volume adjustment may be for adjusting the output difference to be less than or equal to the reference value, using the second calibration value. For example, in a case in which the second calibration value is identified as 3 dB as the third value is identified as 2 dB and the fourth value is identified as 4 dB, the at least one processor 110 may reduce the volume of the third speaker 133 by 3 dB or increase the volume of the fourth speaker 134 by 3 dB. For example, each of the third value and the fourth value may be identified as −1 dB and 1 dB. For another example, in a case in which the second calibration value is identified as −1 dB as the third value is identified as 2 dB and the fourth value is identified as −4 dB, the at least one processor 110 may increase the volume of the third speaker 133 by 1 dB or reduce the volume of the fourth speaker 134 by 1 dB. For example, each of the third value and the fourth value may be identified as 3 dB and −3 dB.

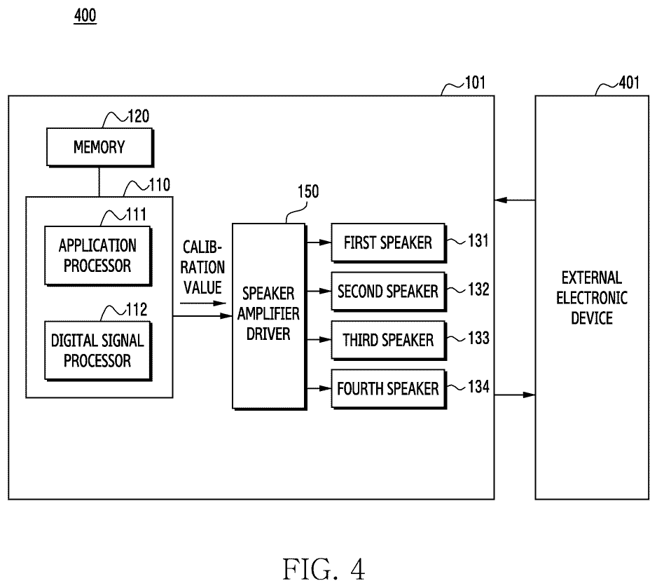

The operation 302, the operation 303, the operation 304, and the operation 305 illustrated in FIG. 3 have been described as the operations performed by the at least one processor 110 in the electronic device 101, but these are exemplary. For example, the at least one processor 110 may perform a portion or all of the operation 302, the operation 303, the operation 304, and the operation 305, using an external electronic device. An example in which the at least one processor 110 performs the operation 302, the operation 303, the operation 304, and the operation 305, using the external electronic device will be described with reference to FIG. 4.

FIG. 4 illustrates another example of a calibration environment for volume adjustment of a speaker of an electronic device.

Referring to FIG. 4, a calibration environment 400 between an electronic device 101 and an external electronic device 401 is illustrated.

The electronic device 101 may include at least one processor 110, memory 120, a first speaker 131, a second speaker 132, a third speaker 133, a fourth speaker 134, and a speaker amplifier driver 150. The at least one processor 110 may include an application processor (AP) 111 and a digital signal processor (DSP) 112.

In an embodiment, the external electronic device 401 may identify (or measure) a volume output from the first speaker 131, a volume output from the second speaker 132, a volume output from the third speaker 133, and a volume output from the fourth speaker 134. The external electronic device 401 may transmit values identifying (or measuring) the volume output from the first speaker 131, the volume output from the second speaker 132, the volume output from the third speaker 133, and the volume output from the fourth speaker 134 to the at least one processor 110 of the electronic device 101. For example, the at least one processor 110 may perform the operation 302, the operation 303, the operation 304, and the operation 305 of FIG. 3 by obtaining values, from the external electronic device 401, identifying (or measuring) the volume output from the first speaker 131, the volume output from the second speaker 132, the volume output from the third speaker 133, and the volume output from the fourth speaker 134.

In an embodiment, the external electronic device 401 may identify (or measure) the volume output from the first speaker 131, the volume output from the second speaker 132, the volume output from the third speaker 133, and the volume output from the fourth speaker 134. After identifying a first calibration value for volume adjustment between the first speaker 131 and the second speaker 132, based on values identifying (or measuring) the volume output from the first speaker 131, and the volume output from the second speaker 132, the external electronic device 401 may transmit the first calibration value to the at least one processor 110. After identifying a second calibration value for volume adjustment between the third speaker 133 and the fourth speaker 134, based on values identifying (or measuring) the volume output from the third speaker 133, and the volume output from the fourth speaker 134, the external electronic device 401 may transmit the second calibration value to the at least one processor 110 of the electronic device 101. The at least one processor 110 may perform the operation 304 and the operation 305 of FIG. 3, by obtaining the first calibration value for the volume adjustment between the first speaker 131 and the second speaker 132, and the second calibration value for the volume adjustment between the third speaker 133 and the fourth speaker 134 from the external electronic device 401.

FIG. 5 is a flowchart illustrating a method of setting a volume of each of speakers of an electronic device using a calibration value.

Referring to FIG. 5, in an operation 501, at least one processor 110 may identify audio data to be played in an electronic device 101.

In an operation 502, the at least one processor 110 may control a speaker amplifier driver 150 to identify whether a first calibration value and a second calibration value exist in a register of the speaker amplifier driver 150, based on identifying the audio data.

In an operation 503, the at least one processor 110 may control the speaker amplifier driver 150 to set volumes of each of a first speaker 131, a second speaker 132, a third speaker 133, and a fourth speaker 134. For example, when the first calibration value is identified as existing, the at least one processor 110 may control the speaker amplifier driver 150 to apply the first calibration value to the volume of the first speaker 131 or the volume of the second speaker 132. For example, when the second calibration value is identified as existing, the at least one processor 110 may control the speaker amplifier driver 150 to apply the second calibration value to the volume of the third speaker 133 or the volume of the fourth speaker 134.

In an operation 504, the at least one processor 110 may output the audio data to be played to an outside of the electronic device 101 via each of the first speaker 131, the second speaker 132, the third speaker 133, and the fourth speaker 134, based on the setting of the volumes of each of the first speaker 131, the second speaker 132, the third speaker 133, and the fourth speaker 134.

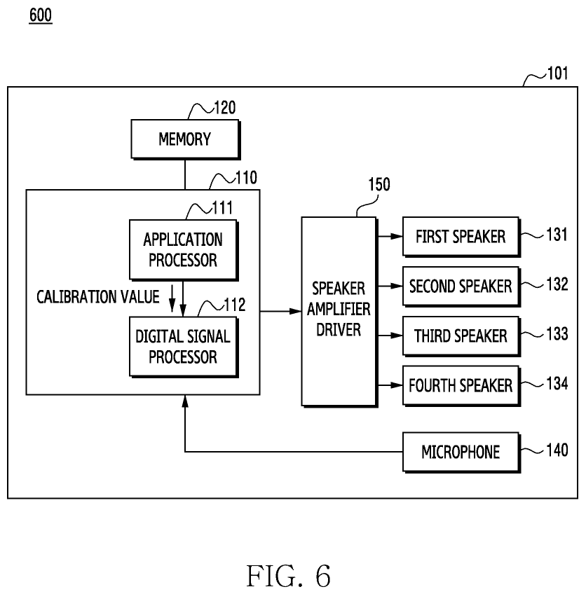

As described above, the electronic device 101 may set the volume of each of the speakers via the speaker amplifier driver 150 to perform volume adjustment between the speakers. According to an embodiment, the electronic device 101 may selectively perform the volume adjustment according to a stream type of the audio data via a digital signal processor 112. An operation method of selectively performing the volume adjustment according to the stream type will be described in FIG. 6.

FIG. 6 illustrates another example of a calibration environment for volume adjustment of a speaker of an electronic device.

Referring to FIG. 6, an electronic device 101 may include at least one processor 110, memory 120, a first speaker 131, a second speaker 132, a third speaker 133, a fourth speaker 134, a microphone 140, and a speaker amplifier driver 150.

For example, the electronic device 101 may increase precision of spatial audio output from speakers, by performing volume adjustment between the first speaker 131 and the second speaker 132 and volume adjustment between the third speaker 133 and the fourth speaker 134. However, it is not limited thereto. For example, the electronic device 101 may perform only volume adjustment between the first speaker 131 and the second speaker 132, or may perform only volume adjustment between the third speaker 133 and the fourth speaker 134. For another example, the electronic device 101 may perform volume adjustment between three or more speakers.

The at least one processor 110 may include an application processor (AP) 111 and a digital signal processor (DSP) 112. For example, the application processor 111 and the digital signal processor 112 may be integrated into a component (e.g., a single chip), or may be implemented as a plurality of separate components (e.g., a plurality of chips).

The application processor 111 may identify audio data to be provided to each of the first speaker 131, the second speaker 132, the third speaker 133, and the fourth speaker 134. For example, the audio data may be described as data related to audio (e.g., music, a voice, and a media sound) to be played in the electronic device 101. For example, the application processor 111 may adjust a size (e.g., gain) of a signal related to the audio data, or filter a frequency of the signal, and/or determine bit depth of the audio data. For example, the application processor 111 may identify audio data components by analyzing (or identifying) the audio data for each frequency range. For example, the application processor 111 may identify, from the audio data, a first audio data component on a first frequency range, a second audio data component on a second frequency range higher than the first frequency range, a third audio data component on a third frequency range higher than the second frequency range, and a fourth audio data component on a fourth frequency range higher than the third frequency range. For example, the first audio data component, the second audio data component, the third audio data component, and the fourth audio data component may be included in the audio data. As an example without limitation, the first frequency range and the second frequency range may be described as a low frequency range. As an example without limitation, the third frequency range and the fourth frequency range may be described as a high frequency range.

For example, a software layer of the application processor 111 may be described as including an application layer and a framework layer. For example, the application processor 111 may identify audio data to be played in the electronic device 101 via the application layer. For example, the application processor 111 may set a playback environment (e.g., stereo or mono) related to the audio data to be played in the electronic device 101 via the framework layer, and/or set a playback priority for the audio data to be played in the electronic device 101.

For example, the application processor 111 may calculate (or identify) a calibration value for the volume adjustment between the first speaker 131 and the second speaker 132 and the volume adjustment between the third speaker 133 and the fourth speaker 134 via the application layer. For example, the application processor 111 may store the calibration value calculated (or identified) via the framework layer in the memory 120. For example, the calibration value may include a first calibration value for the volume adjustment between the first speaker 131 and the second speaker 132 and a second calibration value for the volume adjustment between the third speaker 133 and the fourth speaker 134. For example, when the electronic device 101 is booted, the application processor 111 may read the first calibration value and the second calibration value stored in the memory 120 via the framework layer. For example, the application processor 111 may transmit the read first calibration value and the read second calibration value to the digital signal processor 112 via the framework layer.

The digital signal processor 112 may include processing circuitry for processing the audio data identified by the application processor 111. For example, the digital signal processor 112 may output the audio data to be output to an outside of the electronic device 101 to the first speaker 131, the second speaker 132, the third speaker 133, and the fourth speaker 134, via the speaker amplifier driver 150. For example, the digital signal processor 112 may output the first audio data component on the first frequency range and the second audio data component on the second frequency range to each of the first speaker 131 and the second speaker 132 via the speaker amplifier driver 150. For example, the digital signal processor 112 may output the third audio data component on the third frequency range and the fourth audio data component on the fourth frequency range to each of the third speaker 133 and the fourth speaker 134 via the speaker amplifier driver 150. For example, the digital signal processor 112 may adjust a size (e.g., gain) of a signal related to the audio data and/or filter a frequency of the audio data.

For example, a layer of the digital signal processor 112 may be described as including a stream module, a post processing module, and a device module. For example, each of the stream module, the post processing module, and the device module may be implemented in software and/or hardware. For example, the digital signal processor 112 may output the audio data identified by the application processor 111 to the speaker amplifier driver 150, using sequentially the stream module, the post processing module, and the device module.

For example, the digital signal processor 112 may identify a stream type of the audio data identified by the application processor 111, using the stream module. For example, the stream type may include a first stream type in which the audio data corresponds to music, a video sound, and a game sound, a second stream type in which the audio data corresponds to a telephone bell sound, a third stream type in which the audio data corresponds to an alarm sound, a fourth stream type in which the audio data corresponds to a notification sound and a message sound, a fifth stream type in which the audio data corresponds to a system sound (e.g., key tone and a display touch sound), and a sixth stream type in which the audio data corresponds to a call voice.

For example, the digital signal processor 112 may remove an echo and/or noise of the audio data identified by the application processor 111, or apply an audio effect (e.g., equalizer and reverb) to the audio data, using the post processing module. For example, the digital signal processor 112 may identify whether the identified stream type is a defined stream type, using the post processing module. The defined stream type may be described as a stream type (e.g., the first stream type in which the audio data corresponds to the music, the video sound, and the game sound) providing the spatial audio. For example, the defined stream type may be for providing the spatial audio in which a volume corresponding to the audio data to be output via the first speaker 131 and a volume corresponding to the audio data to be output via the second speaker 132 are different from each other. For example, the defined stream type may be for providing the spatial audio in which a volume corresponding to the audio data to be output via the third speaker 133 and a volume corresponding to the audio data to be output via the fourth speaker 134 are different from each other.

For example, the digital signal processor 112 may identify the first calibration value and the second calibration value transmitted from the application processor 111, using the post processing module. For example, the digital signal processor 112 may, based on the stream type of the audio data being identified as the defined stream type, perform the volume adjustment between the first speaker 131 and the second speaker 132 using the first calibration value. For example, the digital signal processor 112 may, based on the stream type of the audio data being identified as the defined stream type, perform the volume adjustment between the third speaker 133 and the fourth speaker 134 using the second calibration value. For example, by performing the volume adjustment between speakers while the stream type is identified as the defined stream type providing the spatial audio, the electronic device 101 may mitigate a difference in volume between the speakers according to movement of the electronic device 101 based on movement of a user.

For example, the digital signal processor 112 may, using the device module, transmit the audio data identified by the application processor 111 to the speaker amplifier driver 150.

The speaker amplifier driver 150 may be electrically connected to the first speaker 131, the second speaker 132, the third speaker 133, and the fourth speaker 134. For example, by processing the audio data output from the digital signal processor 112, the speaker amplifier driver 150 may output the processed audio data to an outside of the electronic device 101 via each of the first speaker 131, the second speaker 132, the third speaker 133, and the fourth speaker 134.

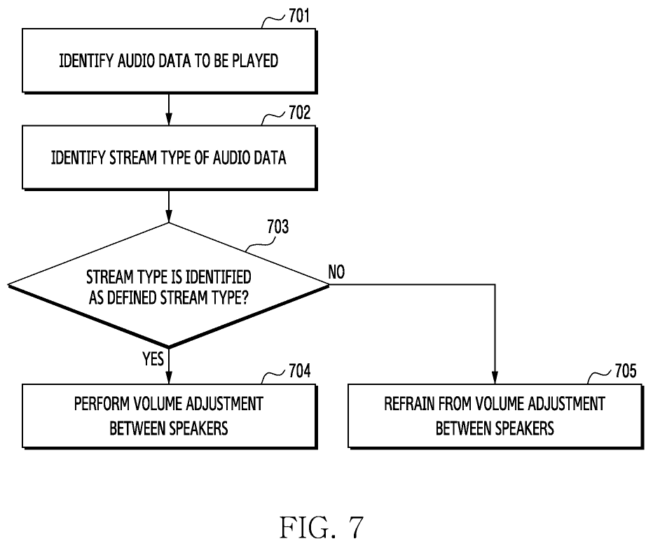

FIG. 7 is a flowchart illustrating a method of performing volume adjustment between speakers according to a stream type of audio data.

Referring to FIG. 7, in an operation 701, at least one processor 110 may identify audio data to be played in an electronic device 101 via an application processor 111. For example, the at least one processor 110 may identify the audio data to be output via a first speaker 131, a second speaker 132, a third speaker 133, and a fourth speaker 134.

In an operation 702, a digital signal processor 112 may identify a stream type of the audio data identified by the application processor 111, using the stream module. For example, the stream type may include a first stream type in which the audio data corresponds to music, a video sound, and a game sound, a second stream type in which the audio data corresponds to a telephone bell sound, a third stream type in which the audio data corresponds to an alarm sound, a fourth stream type in which the audio data corresponds to a notification sound and a message sound, a fifth stream type in which the audio data corresponds to a system sound (e.g., key tone and a display touch sound), and a sixth stream type in which the audio data corresponds to a call voice.

In an operation 703, the digital signal processor 112 may identify whether the identified stream type is a defined stream type, using the post processing module. The defined stream type may be described as a stream type (e.g., the first stream type in which the audio data corresponds to the music, the video sound, and the game sound) providing spatial audio. For example, the defined stream type may be for providing the spatial audio in which a volume corresponding to the audio data to be output via the first speaker 131 and a volume corresponding to the audio data to be output via the second speaker 132 are different from each other. For example, the defined stream type may be for providing the spatial audio in which a volume corresponding to the audio data to be output via the third speaker 133 and a volume corresponding to the audio data to be output via the fourth speaker 134 are different from each other.

In an operation 704, the digital signal processor 112 may, based on the stream type of the audio data being identified as the defined stream type, perform the volume adjustment between speakers. For example, the digital signal processor 112 may identify the first calibration value and the second calibration value transmitted from the application processor 111, using the post processing module. For example, the first calibration value and the second calibration value may be obtained based on the electronic device 101 performing the operation 301, the operation 302, the operation 303, the operation 304, and the operation 305 illustrated in FIG. 3. For example, the digital signal processor 112 may perform the volume adjustment between the first speaker 131 and the second speaker 132 using the first calibration value, based on the stream type of the audio data being identified as the defined stream type. For example, the digital signal processor 112 may perform the volume adjustment between the third speaker 133 and the fourth speaker 134 using the second calibration value, based on the stream type of the audio data being identified as the defined stream type. For example, the volume adjustment may be performed based on the electronic device 101 performing the operation 306 illustrated in FIG. 3. For example, by performing the volume adjustment between speakers while the stream type is identified as the defined stream type providing the spatial audio, the electronic device 101 may mitigate a difference in volume between the speakers according to movement of the electronic device 101 based on movement of a user.

In an operation 705, the digital signal processor 112 may refrain from the volume adjustment between the speakers, based on the stream type of the audio data not being identified as the defined stream type. For example, the digital signal processor 112 may refrain from the volume adjustment between the first speaker 131 and the second speaker 132 and the volume adjustment between the third speaker 133 and the fourth speaker 134, based on the stream type of the audio data not being identified as the defined stream type.

The electronic device 101 may correspond to an electronic device 801 described with reference to FIG. 8 below.

FIG. 8 is a block diagram illustrating an electronic device 801 in a network environment 800 according to various embodiments.

Referring to FIG. 8, the electronic device 801 in the network environment 800 may communicate with an electronic device 802 via a first network 898 (e.g., a short-range wireless communication network), or at least one of an electronic device 804 or a server 808 via a second network 899 (e.g., a long-range wireless communication network). According to an embodiment, the electronic device 801 may communicate with the electronic device 804 via the server 808. According to an embodiment, the electronic device 801 may include a processor 820, memory 830, an input module 850, a sound output module 855, a display module 860, an audio module 870, a sensor module 876, an interface 877, a connecting terminal 878, a haptic module 879, a camera module 880, a power management module 888, a battery 889, a communication module 890, a subscriber identification module(SIM) 896, or an antenna module 897. In some embodiments, at least one of the components (e.g., the connecting terminal 878) may be omitted from the electronic device 801, or one or more other components may be added in the electronic device 801. In some embodiments, some of the components (e.g., the sensor module 876, the camera module 880, or the antenna module 897) may be implemented as a single component (e.g., the display module 860).

The processor 820 may execute, for example, software (e.g., a program 840) to control at least one other component (e.g., a hardware or software component) of the electronic device 801 coupled with the processor 820, and may perform various data processing or computation. According to an embodiment, as at least part of the data processing or computation, the processor 820 may store a command or data received from another component (e.g., the sensor module 876 or the communication module 890) in volatile memory 832, process the command or the data stored in the volatile memory 832, and store resulting data in non-volatile memory 834. According to an embodiment, the processor 820 may include a main processor 821 (e.g., a central processing unit (CPU) or an application processor (AP)), or an auxiliary processor 823 (e.g., a graphics processing unit (GPU), a neural processing unit (NPU), an image signal processor (ISP), a sensor hub processor, or a communication processor (CP)) that is operable independently from, or in conjunction with, the main processor 821. For example, when the electronic device 801 includes the main processor 821 and the auxiliary processor 823, the auxiliary processor 823 may be adapted to consume less power than the main processor 821, or to be specific to a specified function. The auxiliary processor 823 may be implemented as separate from, or as part of the main processor 821.

The auxiliary processor 823 may control at least some of functions or states related to at least one component (e.g., the display module 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). According to an embodiment, the auxiliary processor 823 (e.g., an image signal processor or a communication processor) may be implemented as part of another component (e.g., the camera module 880 or the communication module 890) functionally related to the auxiliary processor 823. According to an embodiment, the auxiliary processor 823 (e.g., the neural processing unit) may include a hardware structure specified for artificial intelligence model processing. An artificial intelligence model may be generated by machine learning. Such learning may be performed, e.g., by the electronic device 801 where the artificial intelligence is performed or via a separate server (e.g., the server 808). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input module 850 may receive a command or data to be used by another component (e.g., the processor 820) of the electronic device 801, from the outside (e.g., a user) of the electronic device 801. The input module 850 may include, for example, a microphone, a mouse, a keyboard, a key (e.g., a button), or a digital pen (e.g., a stylus pen).

The sound output module 855 may output sound signals to the outside of the electronic device 801. The sound output module 855 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 860 may visually provide information to the outside (e.g., a user) of the electronic device 801. The display module 860 may include, for example, a display, a hologram device, or a projector and control circuitry to control a corresponding one of the display, hologram device, and projector. According to an embodiment, the display module 860 may include a touch sensor adapted to detect a touch, or a pressure sensor adapted to measure the intensity of force incurred by the touch.

The audio module 870 may convert a sound into an electrical signal and vice versa. According to an embodiment, the audio module 870 may obtain the sound via the input module 850, or output the sound via the sound output module 855 or a headphone of an external electronic device (e.g., an electronic device 802) directly (e.g., wiredly) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. According to an embodiment, the sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device (e.g., the electronic device 802) directly (e.g., wiredly) or wirelessly. According to an embodiment, the interface 877 may include, for example, a high definition multimedia interface (HDMI), a universal serial bus (USB) interface, a secure digital (SD) card interface, or an audio interface.

A connecting terminal 878 may include a connector via which the electronic device 801 may be physically connected with the external electronic device (e.g., the electronic device 802). According to an embodiment, the connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or electrical stimulus which may be recognized by a user via his tactile sensation or kinesthetic sensation. According to an embodiment, the haptic module 879 may include, for example, a motor, a piezoelectric element, or an electric stimulator.

The camera module 880 may capture a still image or moving images. According to an embodiment, the camera module 880 may include one or more lenses, image sensors, image signal processors, or flashes.

The power management module 888 may manage power supplied to the electronic device 801. According to an embodiment, the power management module 888 may be implemented as at least part of, for example, a power management integrated circuit (PMIC).

The battery 889 may supply power to at least one component of the electronic device 801. According to an embodiment, the battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the application processor (AP)) and supports a direct (e.g., wired) communication or a wireless communication. According to an embodiment, the communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as Bluetooth™, wireless-fidelity (Wi-Fi) direct, or infrared data association (IrDA)) or the second network 899 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The wireless communication module 892 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 892 may support a high-frequency band (e.g., the mmWave band) to achieve, e.g., a high data transmission rate. The wireless communication module 892 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 892 may support various requirements specified in the electronic device 801, an external electronic device (e.g., the electronic device 804), or a network system (e.g., the second network 899). According to an embodiment, the wireless communication module 892 may support a peak data rate (e.g., 20 Gbps or more) for implementing eMBB, loss coverage (e.g., 864 dB or less) for implementing mMTC, or U-plane latency (e.g., 0.5 ms or less for each of downlink (DL) and uplink (UL), or a round trip of 8 ms or less) for implementing URLLC.

The antenna module 897 may transmit or receive a signal or power to or from the outside (e.g., the external electronic device) of the electronic device 801. According to an embodiment, the antenna module 897 may include an antenna including a radiating element composed of a conductive material or a conductive pattern formed in or on a substrate (e.g., a printed circuit board (PCB)). According to an embodiment, the antenna module 897 may include a plurality of antennas (e.g., array antennas). In such a case, at least one antenna appropriate for a communication scheme used in the communication network, such as the first network 898 or the second network 899, may be selected, for example, by the communication module 890 (e.g., the wireless communication module 892) from the plurality of antennas. The signal or the power may then be transmitted or received between the communication module 890 and the external electronic device via the selected at least one antenna. According to an embodiment, another component (e.g., a radio frequency integrated circuit (RFIC)) other than the radiating element may be additionally formed as part of the antenna module 897.

According to various embodiments, the antenna module 897 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 801 and the external electronic device 804 via the server 808 coupled with the second network 899. Each of the electronic devices 802 or 804 may be a device of a same type as, or a different type, from the electronic device 801. According to an embodiment, all or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 801. The electronic device 801 may provide the outcome, with or without further processing of the outcome, as at least part of a reply to the request. To that end, a cloud computing, distributed computing, mobile edge computing (MEC), or client-server computing technology may be used, for example. The electronic device 801 may provide ultra low-latency services using, e.g., distributed computing or mobile edge computing. In another embodiment, the external electronic device 804 may include an internet-of-things (IoT) device. The server 808 may be an intelligent server using machine learning and/or a neural network. According to an embodiment, the external electronic device 804 or the server 808 may be included in the second network 899. The electronic device 801 may be applied to intelligent services (e.g., smart home, smart city, smart car, or healthcare) based on 5G communication technology or IoT-related technology.

The technical problems to be achieved in this document are not limited to those described above, and other technical problems not mentioned herein will be clearly understood by those having ordinary knowledge in the art to which the present disclosure belongs, from the following description.

As described above, an electronic device (e.g., the electronic device 101) may comprise a first speaker (e.g., the first speaker 131), a second speaker (e.g., the second speaker 132), at least one processor (e.g., the at least one processor 110) comprising processing circuitry, and memory (e.g., the memory 120) comprising one or more storage media storing instructions. The instructions, when executed by the at least one processor individually or collectively, may cause the electronic device to output audio data from the at least one processor to each of the first speaker and the second speaker, identify whether an output difference between a volume output from the first speaker and a volume output from the second speaker in a first frequency range and a second frequency range of the audio data is greater than a reference value, based on the output difference greater than the reference value being identified, obtain a calibration value, and based on obtaining the calibration value, adjust a volume of the first speaker or a volume of the second speaker by the calibration value.

For example, the instructions, when executed by the at least one processor individually or collectively, may cause the electronic device to, from the audio data, identify a first audio data component on the first frequency range and a second audio data component on the second frequency range, by outputting the first audio data component on the first frequency range from the at least one processor to each of the first speaker and the second speaker, identify a value corresponding to a difference between the volume output from the first speaker and the volume output from the second speaker as a first value, by outputting the second audio data component on the second frequency range from the at least one processor to each of the first speaker and the second speaker, identify a value corresponding to a difference between the volume output from the first speaker and the volume output from the second speaker as a second value, and based on the first value greater than the reference value or the second value greater than the reference value being identified, identify that the output difference is greater than the reference value.

For example, the calibration value may be between the first value and the second value.

For example, the calibration value may correspond to an average value of the first value and the second value.

For example, the instructions, when executed by the at least one processor individually or collectively, may cause the electronic device to, based on the average value greater than the reference value being identified, identify the reference value as the calibration value, and based on the average value less than another reference value being identified, identify the another reference value as the calibration value. The another reference value may be less than the reference value.

For example, the instructions, when executed by the at least one processor individually or collectively, may cause the electronic device to, based on obtaining the calibration value, store the calibration value in the memory, when the electronic device is booted, read the calibration value stored in the memory by the at least one processor, and based on the read calibration value, adjust the volume of the first speaker or the volume of the second speaker.

For example, the volume adjustment may be, using the calibration value, for adjusting the output difference to less than or equal to the reference value.

For example, the electronic device may further comprise a microphone (e.g., the microphone 140). The instructions, when executed by the at least one processor individually or collectively, may cause the electronic device to, from the audio data, identify a first audio data component on the first frequency range and a second audio data component on the second frequency range, by outputting the first audio data component on the first frequency range from the at least one processor to each of the first speaker and the second speaker, identify, using the microphone, the volume output from the first speaker and the volume output from the second speaker, and by outputting the second audio data component on the second frequency range from the at least one processor to each of the first speaker and the second speaker, identify, using the microphone, the volume output from the first speaker and the volume output from the second speaker.

For example, the calibration value may be obtained from an external electronic device (e.g., the external electronic device 401) identifying the volume output from the first speaker and the volume output from the second speaker.

For example, the electronic device may further comprise a third speaker (e.g., the third speaker 133), and a fourth speaker (e.g., the third speaker 134). The output difference may be a first output difference. The instructions, when executed by the at least one processor individually or collectively, may cause the electronic device to output the audio data from the at least one processor to each of the third speaker and the fourth speaker, identify whether a second output difference between a volume output from the third speaker and a volume output from the fourth speaker in a third frequency range and a fourth frequency range of the audio data is greater than the reference value, based on the second output difference greater than the reference value being identified, obtain another calibration value, and based on obtaining the another calibration value, adjust a volume of the third speaker or a volume of the fourth speaker by the another calibration value. Each of the third frequency range and the fourth frequency range may be higher than the first frequency range and the second frequency range.

For example, the at least one processor may further include a digital signal processor (e.g., the digital signal processor 112) comprising processing circuitry for processing the audio data. The instructions, when executed by the at least one processor individually or collectively, may cause the electronic device to identify a stream type of the audio data, based on the stream type of the audio data being identified as a defined stream type, perform, via the digital signal processor, the volume adjustment, and based on the stream type of the audio data not being identified as the defined stream type, refrain from the volume adjustment.

As described above, a non-transitory computer readable storage medium may store one or more programs. The one or more programs may comprise instructions to, when executed by an electronic device (e.g., the electronic device 101) with a first speaker (e.g., the first speaker 131) and a second speaker (e.g., the electronic device 132), cause the electronic device to output audio data to each of the first speaker and the second speaker, identify whether an output difference between a volume output from the first speaker and a volume output from the second speaker in a first frequency range and a second frequency range of the audio data is greater than a reference value, based on the output difference greater than the reference value being identified, obtain a calibration value, and based on obtaining the calibration value, adjust a volume of the first speaker or a volume of the second speaker by the calibration value.

For example, the one or more programs may comprise instructions to, when executed by the electronic device, cause the electronic device to, from the audio data, identify a first audio data component on the first frequency range and a second audio data component on the second frequency range, by outputting the first audio data component on the first frequency range to each of the first speaker and the second speaker, identify a value corresponding to a difference between the volume output from the first speaker and the volume output from the second speaker as a first value, by outputting the second audio data component on the second frequency range to each of the first speaker and the second speaker, identify a value corresponding to a difference between the volume output from the first speaker and the volume output from the second speaker as a second value, and based on the first value greater than the reference value or the second value greater than the reference value being identified, identify that the output difference is greater than the reference value.

For example, the calibration value may be between the first value and the second value.

For example, the calibration value may correspond to an average value of the first value and the second value.

For example, the volume adjustment may be, using the calibration value, for adjusting the output difference to less than or equal to the reference value.

For example, the electronic device may further comprise a microphone (e.g., the microphone 140). The one or more programs may comprise instructions to, when executed by the electronic device, cause the electronic device to, from the audio data, identify a first audio data component on the first frequency range and a second audio data component on the second frequency range, by outputting the first audio data component on the first frequency range to each of the first speaker and the second speaker, identify, using the microphone, the volume output from the first speaker and the volume output from the second speaker, and by outputting the second audio data component on the second frequency range to each of the first speaker and the second speaker, identify, using the microphone, the volume output from the first speaker and the volume output from the second speaker.

For example, the calibration value may be obtained from an external electronic device (e.g., the external electronic device 401) identifying the volume output from the first speaker and the volume output from the second speaker.

As described above, an electronic device (e.g., the electronic device 101) may comprise a first speaker (e.g., the first speaker 131), a second speaker (e.g., the second speaker 132), at least one processor (e.g., the at least one processor 110) comprising processing circuitry, and memory (e.g., the memory 120) comprising one or more storage media storing instructions. The at least one processor may include a digital signal processor (e.g., the digital signal processor 112) comprising processing circuitry for processing audio data. The instructions, when executed by the at least one processor individually or collectively, may cause the electronic device to identify a stream type of the audio data to be output from the at least one processor to each of the first speaker and the second speaker, based on the stream type of the audio data being identified as a defined stream type, perform, via the digital signal processor, a volume adjustment between the first speaker and the second speaker, and based on the stream type of the audio data not being identified as the defined stream type, refrain from the volume adjustment.

For example, the defined stream type may be for providing a spatial audio in which a volume corresponding to the audio data to be output via the first speaker and a volume corresponding to the audio data to be output via the second speaker are different from each other.

As described above, a non-transitory computer readable storage medium may store one or more programs. The one or more programs may comprise instructions to, when executed by an electronic device (e.g., the electronic device 101) with a first speaker (e.g., the first speaker 131), a second speaker (e.g., the electronic device 132), and a digital signal processor (e.g., the digital signal processor 112) comprising processing circuitry for processing audio data, cause the electronic device to identify a stream type of the audio data to be output from the at least one processor to each of the first speaker and the second speaker, based on the stream type of the audio data being identified as a defined stream type, perform, via the digital signal processor, a volume adjustment between the first speaker and the second speaker, and based on the stream type of the audio data not being identified as the defined stream type, refrain from the volume adjustment.

The effects that may be obtained from the present disclosure are not limited to those described above, and any other effects not mentioned herein will be clearly understood by those having ordinary knowledge in the art to which the present disclosure belongs.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 840) including one or more instructions that are stored in a storage medium (e.g., internal memory 836 or external memory 838) that is readable by a machine (e.g., the electronic device 801). For example, a processor (e.g., the processor 820) of the machine (e.g., the electronic device 801) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a first speaker;
a second speaker;
at least one processor comprising processing circuitry; and
memory comprising one or more storage media storing instructions,
wherein the instructions, when executed by the at least one processor individually or collectively, cause the electronic device to:
output audio data from the at least one processor to each of the first speaker and the second speaker;
identify whether an output difference between a volume output from the first speaker and a volume output from the second speaker in a first frequency range and a second frequency range of the audio data is greater than a reference value;
obtain a calibration value based on the output difference being greater than the reference value; and
adjust a volume of the first speaker or a volume of the second speaker by the calibration value.

2. The electronic device of claim 1, wherein the instructions, when executed by the at least one processor individually or collectively, cause the electronic device to:
identify a first audio data component on the first frequency range and a second audio data component on the second frequency range from the audio data;
identify a value corresponding to a difference between the volume output from the first speaker and the volume output from the second speaker as a first value by outputting the first audio data component on the first frequency range from the at least one processor to each of the first speaker and the second speaker;
identify a value corresponding to a difference between the volume output from the first speaker and the volume output from the second speaker as a second value by outputting the second audio data component on the second frequency range from the at least one processor to each of the first speaker and the second speaker; and
identify that the output difference is greater than the reference value based on the first value being greater than the reference value or the second value being greater than the reference value.

3. The electronic device of claim 2, wherein the calibration value is between the first value and the second value.

4. The electronic device of claim 3, wherein the calibration value corresponds to an average value of the first value and the second value.

5. The electronic device of claim 4, wherein the instructions, when executed by the at least one processor individually or collectively, cause the electronic device to:
identify the reference value as the calibration value based on the average value being greater than the reference value; and
identify another reference value as the calibration value based on the average value being less than another reference value, and
wherein the another reference value is less than the reference value.

6. The electronic device of claim 1, wherein the instructions, when executed by the at least one processor individually or collectively, cause the electronic device to:
based on obtaining the calibration value, store the calibration value in the memory;
when the electronic device is booted, read the calibration value stored in the memory by the at least one processor; and
based on the read calibration value, adjust the volume of the first speaker or the volume of the second speaker.

7. The electronic device of claim 1, wherein the volume adjustment is for adjusting the output difference to less than or equal to the reference value, using the calibration value.

8. The electronic device of claim 1, further comprising:
a microphone,
wherein the instructions, when executed by the at least one processor individually or collectively, cause the electronic device to:
identify a first audio data component on the first frequency range and a second audio data component on the second frequency range from the audio data;
identify, using the microphone, the volume output from the first speaker and the volume output from the second speaker by outputting the first audio data component on the first frequency range from the at least one processor to each of the first speaker and the second speaker; and
identify, using the microphone, the volume output from the first speaker and the volume output from the second speaker by outputting the second audio data component on the second frequency range from the at least one processor to each of the first speaker and the second speaker.

9. The electronic device of claim 1, wherein the calibration value is obtained from an external electronic device identifying the volume output from the first speaker and the volume output from the second speaker.

10. The electronic device of claim 1, further comprising:
a third speaker; and
a fourth speaker,
wherein the output difference is a first output difference,
wherein the instructions, when executed by the at least one processor individually or collectively, cause the electronic device to:
output the audio data from the at least one processor to each of the third speaker and the fourth speaker;
identify whether a second output difference between a volume output from the third speaker and a volume output from the fourth speaker in a third frequency range and a fourth frequency range of the audio data is greater than the reference value;
obtain another calibration value based on the second output difference being greater than the reference value; and
adjust a volume of the third speaker or a volume of the fourth speaker by the another calibration value, and
wherein each of the third frequency range and the fourth frequency range is higher than the first frequency range and the second frequency range.

11. The electronic device of claim 1, wherein the at least one processor further includes a digital signal processor (DSP) comprising processing circuitry for processing the audio data, and
wherein the instructions, when executed by the at least one processor individually or collectively, cause the electronic device to:
identify a stream type of the audio data;
perform, via the DSP, a volume adjustment based on the stream type of the audio data being identified as a defined stream type; and
refrain from the volume adjustment based on the stream type of the audio data not being identified as the defined stream type.

12. A non-transitory computer readable storage medium storing one or more programs, the one or more programs comprising instructions to, when executed by an electronic device with a first speaker and a second speaker, cause the electronic device to:
output audio data to each of the first speaker and the second speaker;
identify whether an output difference between a volume output from the first speaker and a volume output from the second speaker in a first frequency range and a second frequency range of the audio data is greater than a reference value;
obtain a calibration value based on the output difference being greater than the reference value; and
adjust a volume of the first speaker or a volume of the second speaker by the calibration value.

13. The non-transitory computer readable storage medium of claim 12, wherein the one or more programs comprises instructions to, when executed by the electronic device, cause the electronic device to:
identify a first audio data component on the first frequency range and a second audio data component on the second frequency range from the audio data;
identify a value corresponding to a difference between the volume output from the first speaker and the volume output from the second speaker as a first value by outputting the first audio data component on the first frequency range to each of the first speaker and the second speaker;
identify a value corresponding to a difference between the volume output from the first speaker and the volume output from the second speaker as a second value by outputting the second audio data component on the second frequency range to each of the first speaker and the second speaker; and
identify that the output difference is greater than the reference value based on the first value being greater than the reference value or the second value being greater than the reference value.

14. The non-transitory computer readable storage medium of claim 13, wherein the calibration value is between the first value and the second value.

15. The non-transitory computer readable storage medium of claim 14, wherein the calibration value corresponds to an average value of the first value and the second value.

16. The non-transitory computer readable storage medium of claim 12, wherein a volume adjustment is for adjusting the output difference to less than or equal to the reference value, using the calibration value.

17. The non-transitory computer readable storage medium of claim 12, wherein the electronic device further comprises a microphone, and
wherein the one or more programs comprises instructions to, when executed by the electronic device, cause the electronic device to:
identify a first audio data component on the first frequency range and a second audio data component on the second frequency range from the audio data;
identify, using the microphone, the volume output from the first speaker and the volume output from the second speaker by outputting the first audio data component on the first frequency range to each of the first speaker and the second speaker; and
identify, using the microphone, the volume output from the first speaker and the volume output from the second speaker by outputting the second audio data component on the second frequency range to each of the first speaker and the second speaker.

18. The non-transitory computer readable storage medium of claim 12, wherein the calibration value is obtained from an external electronic device identifying the volume output from the first speaker and the volume output from the second speaker.

19. An electronic device comprising:
a first speaker;
a second speaker;
at least one processor comprising processing circuitry, wherein the at least one processor includes a digital signal processor (DSP) comprising processing circuitry for processing audio data; and
memory comprising one or more storage media storing instructions,
wherein the instructions, when executed by the at least one processor individually or collectively, cause the electronic device to:
identify a stream type of the audio data to be output from the at least one processor to each of the first speaker and the second speaker;
perform, via the DSP, a volume adjustment between the first speaker and the second speaker based on the stream type of the audio data being identified as a defined stream type; and
refrain from the volume adjustment based on the stream type of the audio data not being identified as the defined stream type.

20. The electronic device of claim 19, wherein the defined stream type is for providing a spatial audio in which a volume corresponding to the audio data to be output via the first speaker and a volume corresponding to the audio data to be output via the second speaker are different from each other.
